(19) United States
(12) Patent Application Publication
(10) Pub. No.: US 2025/0328485 A1
(43) Pub. Date: Oct. 23, 2025

(54) Network-on-Chip Communication Method and Network-on-Chip Communication System Capable of Performing Communications for Different Networks

(71) Applicant: MEDIATEK INC., Hsin-Chu (TW)

(72) Inventors: Yuan-Chung Lee, Hsinchu City (TW); Yi-Siang Ting, Hsinchu City (TW); Ju-Han Cheng, Hsinchu City (TW); Jyun-Jie Huang, Hsinchu City (TW); Yu-Hsiang Huang, Hsinchu City (TW); Yu-Ping Ho, Hsinchu City (TW)

(73) Assignee: MEDIATEK INC., Hsin-Chu (TW)

(21) Appl. No.: 18/641,444

(22) Filed: Apr. 22, 2024

(51) Int. Cl. G06F 13/42

(52) U.S. Cl. CPC G06F 13/4221; G06F 2213/0026

(57) ABSTRACT

A network-on-chip (NoC) communication method includes providing a first NoC and a second NoC, determining a protocol of linking the first NoC and the second NoC, setting a bridge node in the first NoC to support transactions from a plurality of channels according to the protocol, setting a request node in the second NoC, and linking the request node to the bridge node for communicating with the bridge node through the plurality of channels. The protocol is capable of conveying at least one of a snoop message, a cache maintenance operation (CMO) message, a cache stashing message, a peripheral component interconnect express (PCIe) Ordered Write Observation (OWO) message, or a distributed virtual memory (DVM) message.

### BACKGROUND

With the rapid advancement of technologies, an advanced reduced instruction set computer machine (ARM) is popularly used in many embedded systems and mobile communication designs since it provides energy-saving advantages in conjunction with high operational efficiency. An ARM advanced microcontroller bus architecture (AMBA) is an open-standard, on-chip interconnect specification of the connection and management of functional blocks in system-on-a-chip (SoC) designs. AMBA facilitates the development of multi-processor designs with large numbers of controllers and components with bus architectures. Currently, a first generation of AMBA specification (AMBA 1) to a fifth generation of AMBA specification (AMBA 5) are released for applying to various peripherals.

A network-on-chip (NoC) is a network-based communications subsystem disposed on an integrated circuit. The NoC is typically used between modules in the SoC. For example, an application specific integrated circuit (ASIC) business may require a connection between two different NoCs. However, some request attributes cannot be delivered between two different NoCs. For example, a distributed virtual memory (DVM) operation cannot be achieved between two different NoCs.

Therefore, developing an NoC communication system capable of performing communications between two different NoCs under various AMBA specifications for providing high compatibility and high operational efficiency is an important issue.

### SUMMARY

In an embodiment of the present invention, a network-on-chip (NoC) communication method is disclosed. The NoC communication method comprises providing a first NoC and a second NoC linking with the first NoC with a protocol, setting a bridge node in the first NoC to support transactions from a plurality of channels, setting a request node in the second NoC, and linking the request node in the second NoC to the bridge node for communicating with the bridge node through the plurality of channels. The protocol is capable of conveying at least one of a snoop message, a cache maintenance operation (CMO) message, a cache stashing message, a peripheral component interconnect express (PCIe) Ordered Write Observation (OWO) message, or a distributed virtual memory (DVM) message.

In another embodiment of the present invention, a network-on-chip (NoC) communication method is disclosed. The NoC communication method comprises providing a first NoC and a second NoC, determining a protocol of linking the first NoC and the second NoC, replacing at least one standard bit selected from a plurality of channels of a bridge node in the first NoC with at least one user bit carrying additional protocol information according to the protocol, setting a request node in the second NoC, and linking the request node in the second NoC to the bridge node for communicating with the bridge node through the plurality of channels. The protocol is capable of conveying at least one of a snoop message, a cache maintenance operation (CMO) message, a cache stashing message, a peripheral component interconnect express (PCIe) Ordered Write Observation (OWO) message, or a distributed virtual memory (DVM) message.

In another embodiment of the present invention, a network-on-chip (NoC) system is disclosed. The NoC system comprises a first NoC, a second NoC, a bridge node in the first NoC, and a request node in the second NoC. The request node is linked to the bridge node for communicating with the bridge node through the plurality of channels. The first NoC and the second NoC are linked through the bridge node and the request node according to a protocol. The bridge node in the first NoC is set to support transactions from a plurality of channels. The protocol is capable of conveying at least one of a snoop message, a cache maintenance operation (CMO) message, a cache stashing message, a peripheral component interconnect express (PCIe) Ordered Write Observation (OWO) message, or a distributed virtual memory (DVM) message.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a network-on-chip communication system according to an embodiment of the present invention.

FIG. 2 is an illustration of locating a memory in one downstream network-on-chip under a peripheral component interconnect express ordered write observation process of the network-on-chip communication system in FIG. 1.

FIG. 3 is an illustration of introducing a plurality of downstream networks-on-chip under the peripheral component interconnect express ordered write observation process of the network-on-chip communication system in FIG. 1.

FIG. 4 is an illustration of two networks-on-chip communicating under a distributed virtual memory process of the network-on-chip communication system in FIG. 1.

FIG. 5 is an illustration of two networks-on-chip communicating under a cache maintenance operation of the network-on-chip communication system in FIG. 1.

FIG. 6 s an illustration of two networks-on-chip communicating under a snoop requesting process of the network-on-chip communication system in FIG. 1.

FIG. 7 is a flow chart of performing a network-on-chip communication method by the network-on-chip communication system in FIG. 1.

### DETAILED DESCRIPTION

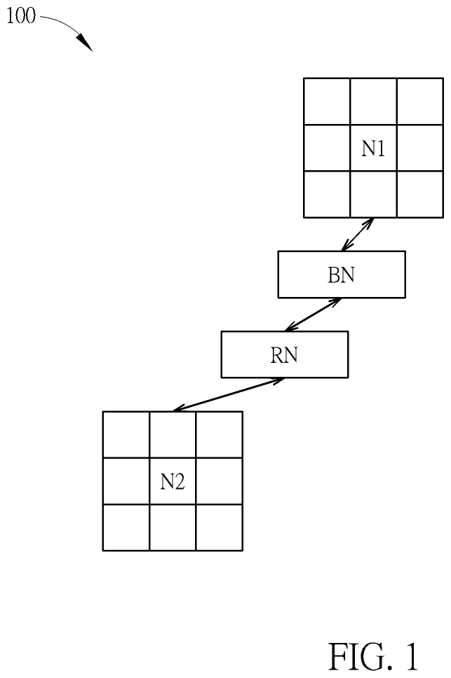

FIG. 1 is a block diagram of a network-on-chip (NoC) communication system 100 according to an embodiment of the present invention. The NoC communication system 100 can be applied to bus architectures under an advanced reduced instruction set computer machine (ARM) family. For example, the NoC communication system 100 can be applied to an advanced microcontroller bus architecture (AMBA) specification of the ARM family. The NoC communication system 100 includes a first NoC N1 and a second NoC N2. The first NoC N1 and the second NoC N2 are two different NoCs. The bridge node BN is in the first NoC N1. Particularly, the bridge node BN can be a modified subordinate node (or say, a modified slave node) in the first NoC N1. The request node RN in the second NoC N2 is linked to the bridge node BN for communicating with the bridge node BN through the plurality of channels. Here, the request node RN can also be called as a master mode. In the NoC communication system 100, after a standard protocol of linking the first NoC N1 and the second NoC N2 is determined, the bridge node BN can be set to support transactions from a plurality of channels according to the standard protocol. To be noted, the term “transaction” in this disclosure means the communications between IP blocks, including but not limited to NoCs, requester devices and completer devices. Generally, the communication refers to read, write, or extension actions, but it doesn't limit thereto in the embodiments of the present invention.

For example, the standard protocol can be selected from the AMBA specification of the ARM family. The plurality of channels of the bridge node BN can be set according to the AMBA specification. For example, P standard channels of the subordinate node under the AMBA specification are pre-defined. However, the subordinate node can be redefined as the bridge node BN by introducing additional Q channels so that (P+Q) channels can be used for communicating the first NoC N1 with the second NoC N2. P and Q are two positive integers. In other words, the bridge node BN can support transactions from at least one standard channel of the standard protocol and at least one additional channel. Therefore, no transactions loss is introduced to the NoC communication system 100. Finally, the first NoC N1 and the second NoC N2 can communicate with each other. Details of setting the bridge node BN and communicating between the first NoC N1 and the second NoC N2 under various AMBA specifications and applications are illustrated below. It should be understood that the first NoC N1 and second NoC N2 might vary in their design and functionality. However, alternatively, they could be two instances of the identical Network on Chip model.

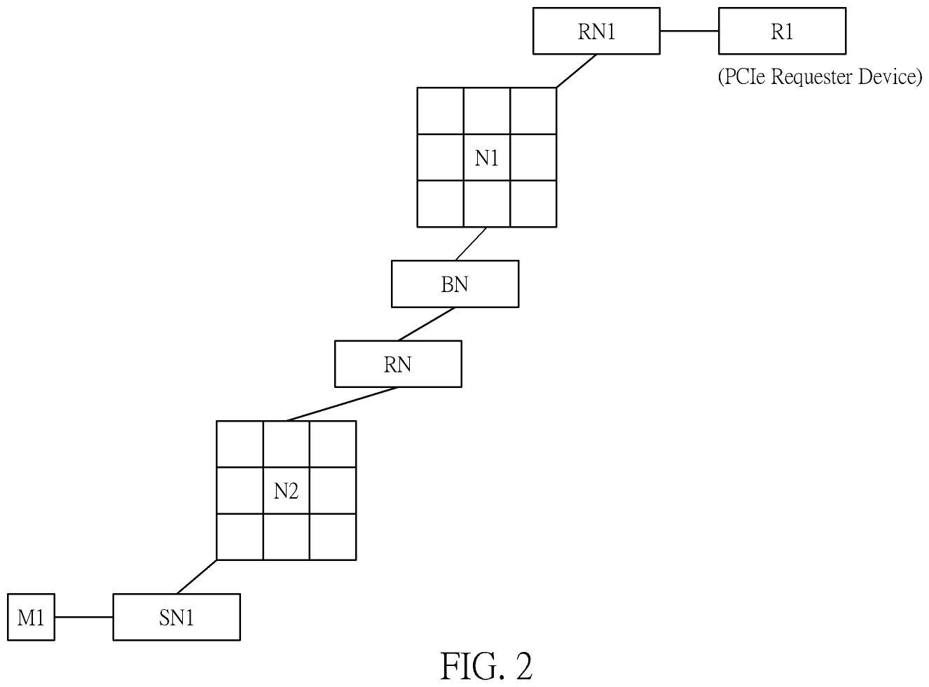

FIG. 2 is an illustration of locating a memory M1 in one downstream NoC (the second NoC N2) under a peripheral component interconnect express (PCIe) ordered write observation (OWO) process of the NoC communication system 100. Here, the NoC communication system 100 can further include a first requester device R1, a first request node RN1 in the first NoC N1 linked to the first requester device R1, the memory M1, and a first subordinate node SN1 in the second NoC N2 linked to the memory M1. Here, the first requester device R1 can be a PCIe requester device. The first NoC N1 and the second NoC N2 can communicate to perform the PCIe OWO process. In FIG. 2, the first request node RN1 can be an I/O-coherence request node (RN-I) or a fully-coherence request node (RN-F). The bridge node BN can be designed according to an I/O-coherence subordinate node (SN-I) or a fully-coherence subordinate node (SN-F). Here, the bridge node BN can be used for relaying transaction identifiers and acknowledgment signals, or can be used for relaying request ordering fields and acknowledgment signals for different AMBA specifications. For example, the first requester device R1 can transmit downstream transactions to the memory M1 through the first request node RN1 in the first NoC N1, the bridge node BN in the first NoC N1, the request node RN in the second NoC N2, and the first subordinate node SN1 in the second NoC N2. When the standard protocol is an advanced extensible interface (AXI) protocol, an AXI coherency extensions (ACE) protocol, or an ACE_lite (ACE5_lite) protocol, the downstream transactions delivered by the bridge node BN can include the transaction identifiers (IDs) and the acknowledgment signals. When the standard protocol is a coherent hub interface (CHI) protocol, the downstream transactions delivered by the bridge node BN can include the request ordering fields and the acknowledgment signals. The transaction IDs or the request ordering fields delivered by the bridge node BN can be used for the OWO process to guarantee an observation order of writing transactions from a single agent by other observers. The acknowledgment signals can be response signals. Further, the OWO process can support producer-consumer ordering models.

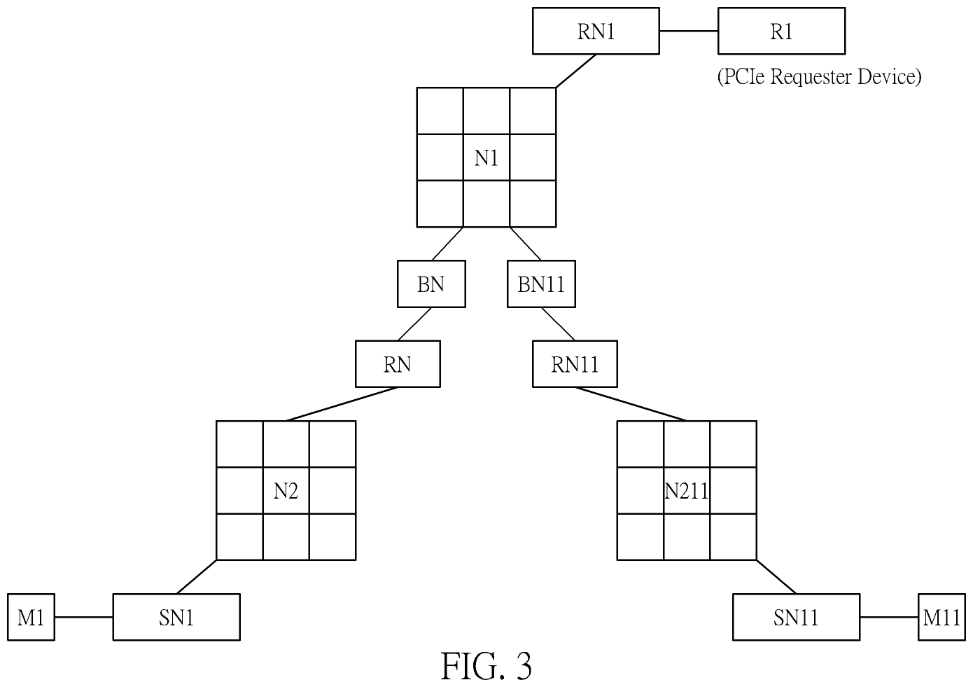

FIG. 3 is an illustration of introducing a plurality of downstream NoCs under the PCIe OWO process of the NoC communication system 100. In the NoC communication system 100, the plurality of downstream NoCs can be introduced. In FIG. 3, the NoC communication system 100 can further include a bridge node BN11 in the first NoC N1, a third NoC N211, a request node RN11 in the third NoC N211, a memory M11, and a subordinate node SN11 in the third NoC N211 linked to the memory M11. In FIG. 3, the bridge nodes BN and BN11 can be symmetrically disposed and independently operated. The request nodes RN and RN11 can be symmetrically disposed and independently operated. The second NoC N2 and the third NoC N211 can be symmetrically disposed and independently operated. The subordinate nodes SN1 and SN11 can be symmetrically disposed and independently operated. The memory M1 and memory M11 can be symmetrically disposed and independently operated. In other words, the first requester device R1 can transmit the downstream transactions to the memory M1 through the request node RN1 in the first NoC N1, the bridge node BN in the first NoC N1, the request node RN in the second NoC N2, and the subordinate node SN1 in the second NoC N2. Further, the first requester device R1 can transmit another downstream transactions to the memory M11 through the request node RN1 in the first NoC N1, the bridge node BN11 in the first NoC N1, the request node RN11 in the third NoC N211, and the subordinate node SN11 in the third NoC N211. In FIG. 3, transactions types and contents delivered by the bridge nodes BN and BN11 are similar. Thus, details are omitted here.

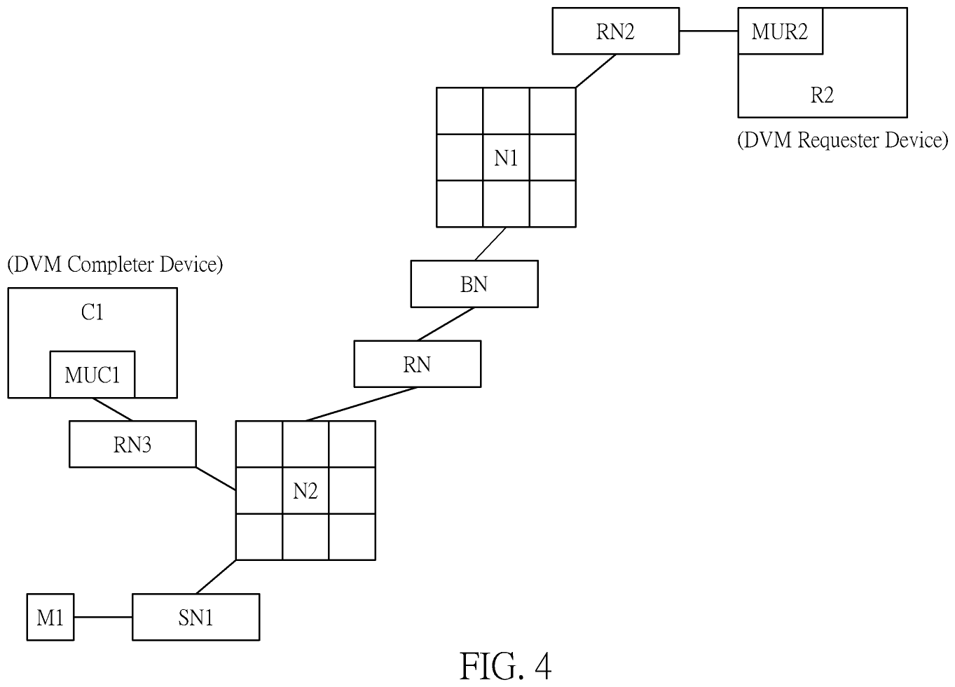

FIG. 4 is an illustration of two NoCs communicating under a distributed virtual memory (DVM) process of the NoC communication system 100. Here, the NoC communication system 100 can further include a second requester device R2, a second request node RN2 in the first NoC N1 linked to the second requester device R2, a first completer device C1, and a third request node RN3 in the second NoC N2 linked to the first completer device C1. Here, the second requester device R2 can be a DVM requester device. The first completer device C1 can be a DVM completer device. In FIG. 4, the second request node RN2 can be a DVM request node (RN-D) linked to a memory management unit (MMU) MUR2 of the second requester device R2. The third request node RN3 can be an RN-D linked to an MMU MUC1 of the first completer device C1. The first NoC and the second NoC can communicate to perform the DVM process. The bridge node BN can be designed according to a SN-I/SN-F or a DVM subordinate node (SN-D). Here, the bridge node BN can be used for relaying DVM messages for different AMBA specifications. For example, the second requester device R2 can transmit downstream transactions to the first completer device C1 through the second request node RN2 in the first NoC N1, the bridge node BN in the first NoC N1, the request node RN in the second NoC N2, and the third request node RN3 in the second NoC N2. When the standard protocol is the ACE protocol, the ACE_lite+DVM (ACE5_lite+DVM) protocol, or the CHI protocol, the downstream transactions delivered by the bridge node BN can include the DVM messages. In an embodiment, for the ACE protocol or the ACE_lite+DVM (ACE5_lite+DVM) protocol, to achieve transactions between the first NoC N1 and the second NoC N2 under the DVM process, additional channels including a snoop address channel (AC) and a snoop response channel (CR) can be introduced to the subordinate node for generating the bridge node BN. For the CHI protocol, to achieve transactions between the first NoC N1 and the second NoC N2 under the DVM process, additional channels including an outbound response channel (RSP) and an inbound snoop channel (SNP) can be introduced to the subordinate node for generating the bridge node BN. In other words, since the bridge node BN supports accessing the DVM messages from additional channels, the first NoC N1 and the second NoC N2 can communicate under the DVM process. Finally, virtual memory addresses controlled by the MMU MUR2 of the second requester device R2 and the MMU MUC1 of the first completer device C1 can be managed.

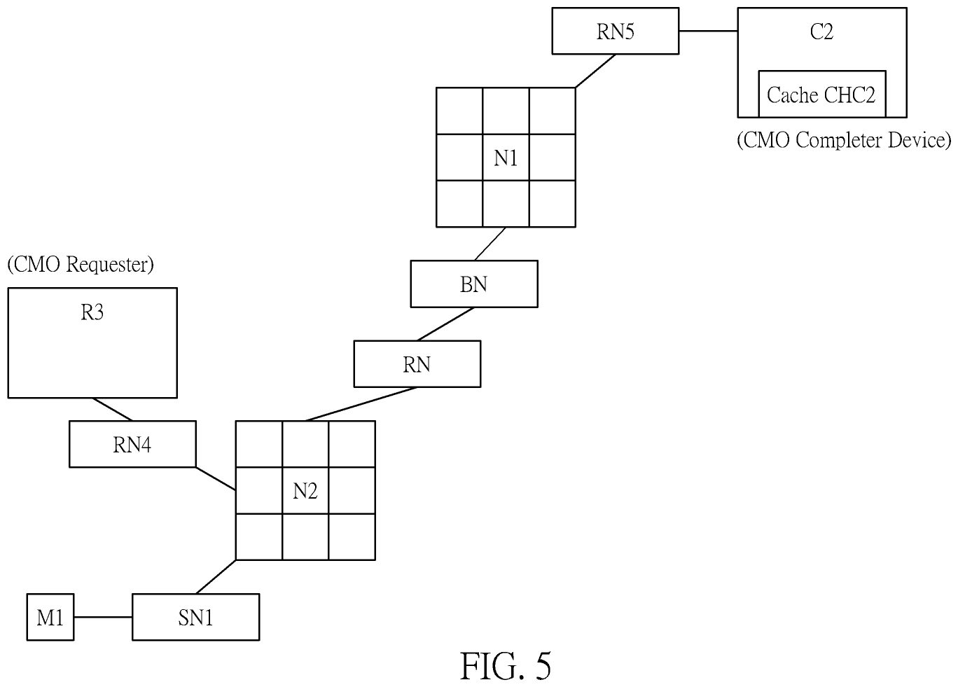

FIG. 5 is an illustration of two NoCs communicating under a cache maintenance operation (CMO) of the NoC communication system 100. Here, the NoC communication system 100 can further include a third requester device R3, a fourth request node RN4 in the second NoC N2 linked to the third requester device R3, a second completer device C2, and a fifth request node RN5 in the first NoC N1 linked to the second completer device C2. Here, the third requester device R3 can be a CMO requester device. The second completer device C2 can be a CMO completer device. The first NoC N1 and the second NoC N2 can communicate to perform the CMO. In FIG. 5, the fourth request node RN4 and the fifth request node RN5 can be the RN-I or the RN-F. The bridge node BN can be designed according to the SN-I or the SN-F. Here, the bridge node BN can be used for relaying CMO messages for different AMBA specifications. For example, the third requester device R3 can transmit upstream transactions to the second completer device C2 through the fourth request node RN4 in the second NoC N2, the request node RN in the second NoC N2, the bridge node BN in the first NoC N1, and the fifth request node RN5 in the first NoC N1. When the standard protocol is the ACE protocol, the ACE_lite (ACE5_lite) protocol, or the CHI protocol, the upstream transactions received or delivered by the bridge node BN can include CMO messages. In an embodiment, for the ACE protocol or the ACE_lite (ACE5_lite) protocol, to achieve transactions between the first NoC N1 and the second NoC N2 under the CMO, additional channels including the snoop address channel (AC) and the snoop response channel (CR) can be introduced to the subordinate node for generating the bridge node BN. For the CHI protocol, to achieve transactions between the first NoC N1 and the second NoC N2 under the CMO, additional channels including the outbound response channel (RSP) and the inbound snoop channel (SNP) can be introduced to the subordinate node for generating the bridge node BN. In other words, since the bridge node BN supports accessing the CMO messages from additional channels, the first NoC N1 and the second NoC N2 can communicate under the CMO. Finally, operations of invalidating, cleaning, or zeroing a cache CHC2 of the second completer device C2 under the CMO can be achieved.

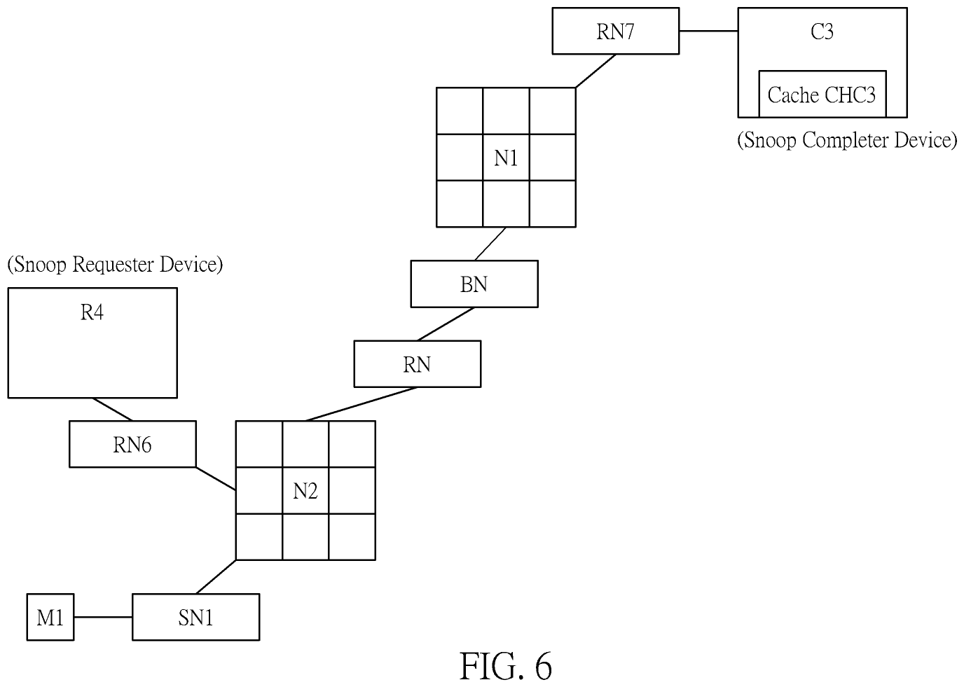

FIG. 6 is an illustration of two NoCs communicating under a snoop requesting process of the NoC communication system 100. Here, the NoC communication system 100 can further include a fourth requester device R4, a sixth request node RN6 in the second NoC N2 linked to the fourth requester device R4, a third completer device C3, and a seventh request node RN7 in the first NoC N1 linked to the third completer device C3. Here, the fourth requester device R4 can be a snoop requester device. The third completer device C3 can be a snoop completer device. The first NoC N1 and the second NoC N2 can communicate to perform a snoop requesting process. In FIG. 6, the sixth request node RN6 can be the RN-I or the RN-F. The seventh request node RN7 can be the RN-F. The bridge node BN can be designed according to the SN-I or the SN-F. Here, the bridge node BN can be used for relaying snoop messages for different AMBA specifications. For example, the fourth requester device R4 can transmit upstream transactions to the third completer device C3 through the sixth request node RN6 in the second NoC N2, the request node RN in the second NoC N2, the bridge node BN in the first NoC N1, and the seventh request node RN7 in the first NoC N1. When the standard protocol is the ACE protocol, the ACE_lite (ACE5_lite) protocol, or the CHI protocol, the upstream transactions received or delivered by the bridge node BN can include snoop messages. In an embodiment, for the ACE protocol or the ACE_lite (ACE5_lite) protocol, to achieve transactions between the first NoC N1 and the second NoC N2 under the snoop requesting process, additional channels including the snoop address channel (AC) and the snoop response channel (CR) can be introduced to the subordinate node for generating the bridge node BN. Further, to transmit carried data from the third completer device C3 to the fourth requester device R4, the additional channels supported by the bridge node BN can further include a snoop data channel (CD). For the CHI protocol, to achieve transactions between the first NoC N1 and the second NoC N2 under the snoop requesting process, additional channels including the outbound response channel (RSP) and the inbound snoop channel (SNP) can be introduced to the subordinate node for generating the bridge node BN. Specifically, since the CHI protocol is a packet-based protocol, a present standard channel (i.e., such as a data channel DAT) supported by the subordinate node can be re-used by the bridge node BN for transmitting the carried data from the third completer device C3 to the fourth requester device R4. In other words, the cache CHC3 of the third completer device C3 can be snooped by the fourth requester device R4. Further, the third completer device C3 can transmit carried data to the fourth requester device R4 through the seventh request node RN7 in the first NoC N1, the bridge node BN in the first NoC N1, the request node RN in the second NoC N2, and the sixth request node RN6 in the second NoC N2 after the cache CHC3 of the third completer device C3 is snooped.

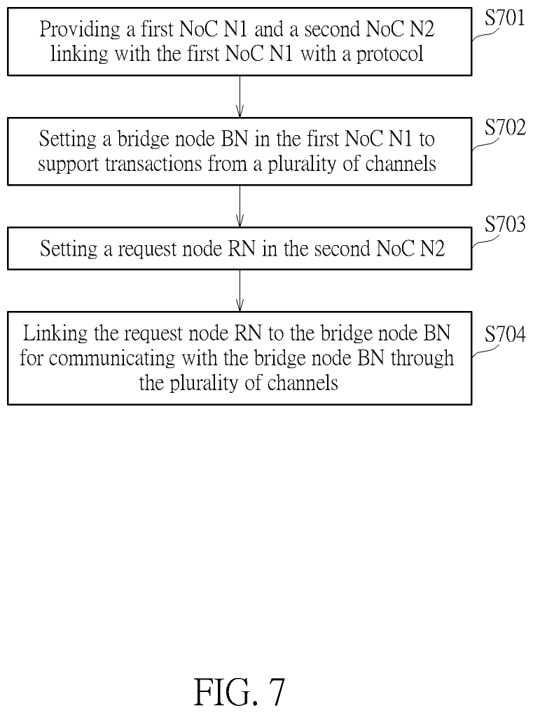

FIG. 7 is a flow chart of performing an NoC communication method by the NoC communication system 100. The NoC communication method includes step S701 to step S704. Any reasonable technology or hardware modification falls into the scope of the present invention.
Step S701 to step S704 are illustrated below.
step S701: providing a first NoC N1 and a second NoC N2 linking with the first NoC N1 with a protocol;
step S702: setting a bridge node BN in the first NoC N1 to support transactions from a plurality of channels;
step S703: setting a request node RN in the second NoC N2;
step S704: linking the request node RN to the bridge node BN for communicating with the bridge node BN through the plurality of channels;

Details of step S701 to step S704 are previously illustrated. Thus, they are omitted here. The step S702 and S703 can be in any order. In the NoC communication system 100, since the bridge node BN is used by introducing additional channels of a standard subordinate node, the bridge node BN can be regarded as a modified subordinate node compatible with linking to the request node under various AMBA specifications. Therefore, different NoCs (or NoCs with the same type) can communicate under various AMBA specifications. By doing so, the NoC communication system 100 can be applied to any process under AMBA specifications of the ARM family, providing high capability and high operational efficiency.

Further, in another embodiment, at least one user-defined bit (i.e., at least one user bit or reserved bit at a specific or predetermined signaling field) carrying additional protocol information can be used for replacing at least one standard bit selected from a plurality of channels according to the standard protocol. For example, at least one user bit of AXUSER in AXI protocol can be user-defined bits used for carrying additional protocol information. For example, at least one user bit of RSVDC in CHI protocol can be specific bits used for carrying additional protocol information. The at least one user bit can replace the standard snoop channel. In other words, in another embodiment, the NoC communication system can use a “modified” snoop channel for achieving communications between different NoCs. Any reasonable technology or hardware modification falls into the scope of the present invention.

In aforementioned embodiments, the “request node” can be regarded as a master network interface (or say, “Master NI”). The request node can be a fully coherent request node, an I/O coherent node, or an I/O coherent request node with DVM support. The fully coherent request node is linked to a device with a hardware-coherent cache. It can permit to do all transactions as defined by the protocol, and can supports all Snoop transactions. The I/O coherent node is linked to a device lacking hardware-coherent cache. It is used for generating a subset of transactions defined by the protocol exclusive of receiving DVM transactions. The I/O coherent request node with DVM support is linked to a device with MMU. It can receive or generate DVM transactions. Further, the “subordinate node” can be regarded as a slave network interface (or, say “Slave NI”). The subordinate node can receive a request from a home node, complete required action, and returns a response. The subordinate node can be used for the normal memory and/or the peripheral devices. Here, any network node performs functionalities of the request node (Master NI) or the subordinate node (Slave NI) falls into the scope of the present invention.

To sum up, the present invention discloses an NoC communication method and an NoC communication system. The NoC communication system introduces a bridge node for communicating different NoCs under various AMBA specifications of the ARM family. Specifically, the bridge node BN can support transactions from at least one standard channel of the standard protocol and at least one additional channel or ordering fields. Alternatively, in other embodiments, different NoCs can communicate without using the standard snoop channel or same transaction ID. For example, at least one customized user bit or specific user bit can be used for replacing the standard snoop channel or transaction ID. By doing so, the NoC communication system can be applied to any process under AMBA specifications of the ARM family, providing high capability and high operational efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network-on-chip (NoC) communication method comprising:
providing a first NoC and a second NoC linking with the first NoC with a protocol;
setting a bridge node in the first NoC to support transactions from a plurality of channels;
setting a request node in the second NoC; and
linking the request node to the bridge node for communicating with the bridge node through the plurality of channels;
wherein the protocol is capable of conveying at least one of a snoop message, a cache maintenance operation (CMO) message, a cache stashing message, a peripheral component interconnect express (PCIe) Ordered Write Observation (OWO) message, or a distributed virtual memory (DVM) message.

2. The method of claim 1, further comprising:
linking a first request node in the first NoC to a first requester device;
linking a first subordinate node in the second NoC to a memory; and
transmitting downstream transactions from the first requester device to the memory through the first request node in the first NoC, the bridge node in the first NoC, the request node in the second NoC, and the first subordinate node in the second NoC;
wherein the first NoC and the second NoC are communicated to perform a PCIe OWO process.

3. The method of claim 2, wherein when the protocol is an advanced extensible interface (AXI) protocol, an AXI coherency extensions (ACE) protocol, or an ACE_lite protocol, the downstream transactions comprises transaction identifiers and acknowledgment signals, and when the protocol is a coherent hub interface (CHI) protocol, the downstream transactions comprises request ordering fields and acknowledgment signals.

4. The method of claim 1, further comprising:
linking a second request node in the first NoC to a second requester device;
linking a third request node in the second NoC to a first completer device; and
transmitting downstream transactions from the second requester device to the first completer device through the second request node in the first NoC, the bridge node in the first NoC, the request node in the second NoC, and the third request node in the second NoC;
wherein the first NoC and the second NoC are communicated to perform a DVM process, the second request node is a DVM request node linked to a memory management unit (MMU) of the second requester device, and the third request node is a DVM request node linked to an MMU of the first completer device.

5. The method of claim 4, wherein when the protocol is an advanced extensible interface coherency extensions (ACE) protocol, an ACE_lite+DVM protocol, or a coherent hub interface (CHI) protocol, the downstream transactions comprises DVM messages.

6. The method of claim 1, further comprising:
linking a fourth request node in the second NoC to a third requester device;
linking a fifth request node in the first NoC to a second completer device; and
transmitting upstream transactions from the third requester device to the second completer device through the fourth request node in the second NoC, the request node in the second NoC, the bridge node in the first NoC, and the fifth request node in the first NoC;
wherein the first NoC and the second NoC are communicated to perform a CMO, the CMO comprises operations of invalidating, cleaning, or zeroing a cache of the second completer device.

7. The method of claim 6, wherein when the protocol is an advanced extensible interface coherency extensions (ACE) protocol, an ACE_lite protocol, or a coherent hub interface (CHI) protocol, the upstream transactions comprises CMO messages.

8. The method of claim 1, further comprising:
linking a sixth request node in the second NoC to a fourth requester device;
linking a seventh request node in the first NoC to a third completer device; and
transmitting upstream transactions from the fourth requester device to the third completer device through the sixth request node in the second NoC, the request node in the second NoC, the bridge node in the first NoC, and the seventh request node in the first NoC;
wherein the first NoC and the second NoC are communicated to perform a snoop requesting process, and when the protocol is an advanced extensible interface coherency extensions (ACE) protocol, an ACE_lite protocol, or a coherent hub interface (CHI) protocol, the upstream transactions comprises snoop messages.

9. The method of claim 8, further comprising:
transmitting carried data from the third completer device to the fourth requester device through the seventh request node in the first NoC, the bridge node in the first NoC, the request node in the second NoC, and the sixth request node in the second NoC after a cache of the third completer device is snooped.

10. A network-on-chip (NoC) communication method comprising:
providing a first NoC and a second NoC;
determining a protocol of linking the first NoC and the second NoC;
setting a bridge node in the first NoC;
replacing at least one standard bit selected from a plurality of channels of the bridge node with at least one user bit carrying additional protocol information according to the protocol;
setting a request node in the second NoC; and
linking the request node to the bridge node for communicating with the bridge node through the plurality of channels;
wherein the protocol is capable of conveying at least one of a snoop message, a cache maintenance operation (CMO) message, a cache stashing message, a peripheral component interconnect express (PCIe) Ordered Write Observation (OWO) message, or a distributed virtual memory (DVM) message.

11. A network-on-chip (NoC) communication system comprising:
a first NoC;
a second NoC;
a bridge node in the first NoC; and
a request node in the second NoC linked to the bridge node for communicating with the bridge node through the plurality of channels;
wherein the first NoC and the second NoC are linked through the bridge node and the request node according to a protocol, the bridge node in the first NoC is set to support transactions from a plurality of channels, the protocol is capable of conveying at least one of a snoop message, a cache maintenance operation (CMO) message, a cache stashing message, a peripheral component interconnect express (PCIe) Ordered Write Observation (OWO) message, or a distributed virtual memory (DVM) message.

12. The system of claim 11, further comprising:
a first requester device;
a first request node in the first NoC linked to the first requester device;
a memory; and
a first subordinate node in the second NoC linked to the memory;
wherein the first requester device transmits downstream transactions to the memory through the first request node in the first NoC, the bridge node in the first NoC, the request node in the second NoC, and the first subordinate node in the second NoC, and the first NoC and the second NoC are communicated to perform a PCIe OWO process.

13. The system of claim 12, wherein when the protocol is an advanced extensible interface (AXI) protocol, an AXI coherency extensions (ACE) protocol, or an ACE_lite protocol, the downstream transactions comprises transaction identifiers and acknowledgment signals, and when the protocol is a coherent hub interface (CHI) protocol, the downstream transactions comprises request ordering fields and acknowledgment signals.

14. The system of claim 11, further comprising:
a second requester device;
a second request node in the first NoC linked to the second requester device;
a first completer device; and
a third request node in the second NoC linked to the first completer device;
wherein the second requester device transmits downstream transactions to the first completer device through the second request node in the first NoC, the bridge node in the first NoC, the request node in the second NoC, and the third request node in the second NoC, the first NoC and the second NoC are communicated to perform a DVM process, the second request node is a DVM request node linked to a memory management unit (MMU) of the second requester device, and the third request node is a DVM request node linked to an MMU of the first completer device.

15. The system of claim 14, wherein when the protocol is an advanced extensible interface coherency extensions (ACE) protocol, an ACE_lite+DVM protocol, or a coherent hub interface (CHI) protocol, the downstream transactions comprises DVM messages.

16. The system of claim 11, further comprising:
a third requester device;
a fourth request node in the second NoC linked to the third requester device;
a second completer device; and
a fifth request node in the first NoC linked to the second completer device;
wherein the third requester device transmits upstream transactions to the second completer device through the fourth request node in the second NoC, the request node in the second NoC, the bridge node in the first NoC, and the fifth request node in the first NoC, the first NoC and the second NoC are communicated to perform a CMO, and the CMO comprises operations of invalidating, cleaning, or zeroing a cache of the second completer device.

17. The system of claim 16, wherein when the protocol is an advanced extensible interface coherency extensions (ACE) protocol, an ACE_lite protocol, or a coherent hub interface (CHI) protocol, the upstream transactions comprises CMO messages.

18. The system of claim 11, further comprising:
a fourth requester device;
a sixth request node in the second NoC linked to the fourth requester device;
a third completer device; and
a seventh request node in the first NoC linked to the third completer device;
wherein the fourth requester device transmits upstream transactions to the third completer device through the sixth request node in the second NoC, the request node in the second NoC, the bridge node in the first NoC, and the seventh request node in the first NoC, and the first NoC and the second NoC are communicated to perform a snoop requesting process.

19. The system of claim 18, wherein when the protocol is an advanced extensible interface coherency extensions (ACE) protocol, an ACE_lite protocol, or a coherent hub interface (CHI) protocol, the upstream transactions comprises snoop messages.

20. The system of claim 18, wherein the third completer device transmits carried data to the fourth requester device through the seventh request node in the first NoC, the bridge node in the first NoC, the request node in the second NoC, and the sixth request node in the second NoC after a cache of the third completer device is snooped.
